(19) United States
(12) Patent Application Publication
(10) Pub. No.: US 2003/0041981 A1
(43) Pub. Date: Mar. 6, 2003

(54) Aerogel-insulated overhead door

(76) Inventor: Benedict F. Cramer III, Huntington Station, NY (US)

Correspondence Address: Richard P. Fennelly, 1386 Quarry Drive, Mohegan Lake, NY, 10547, US

(21) Appl. No.: 10/234,608

(22) Filed: Sep. 4, 2002

Related U.S. Application Data
(60) Provisional application No. 60/317,072, filed on Sep. 5, 2001.

(51) Int. Cl. E06B 3/12

(52) U.S. Cl. 160/232

(57) ABSTRACT

Insulated overhead doors, which comprise a plurality of slats or panels defined by front, back, and side surfaces with an insulating material disposed therein, can be insulated quite effectively by the use of an aerogel material as the insulant. Aerogel materials that are in fiber-reinforced monolithic form or that are granular aerogel in vacuum insulated panels can be utilized for the present invention.

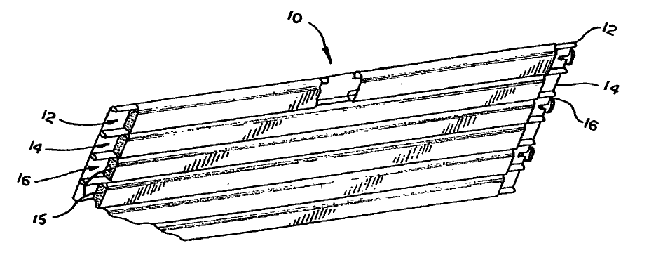

This application claims the benefit of U.S. Provisional Patent Application Ser. No. 60/317,072, filed Sept. 5, 2001.

Overhead doors are designed to be raised and lowered, e.g., by residing on tracks, to cover an opening (e.g., one leading to a residential or commercial garage, one providing entry to a refrigeration vehicle, or some other structural opening). Such doors comprise a plurality of slats or panels that have front, back and, optionally, side surfaces. They are well-known items of commerce. For example, overhead rolling steel doors comprise a plurality of linked slats whereas sectional overhead doors comprise a plurality of wider linked panels. Existing insulated doors of this type use foamed plastics as the insulation material within the normally hollow space within the slat or panel, as exemplified by the following patents, which are incorporated herein by reference in their entirety, as showing the existing state of the art: U.S. Pat. Nos. 3,724,526; 4,183,393; 4,441,301; 4,746,383; 4,979,553; 5,060,711; 5,419,386; and 5,533,312

The present invention, in its broadest embodiment, involves the use of aerogel as a novel insulation material for any such type of overhead door.

The aerogel material, for example, can be the type of fiber-reinforced monolithic aerogel that is described in U.S. Pat. No. 6,068,882 to J. Ryu, which patent is incorporated herein by reference in its entirety. Preferably, the fibers are ceramic in such a construction making the entire construction essentially fireproof. Such a product is commercially available from Aspen Systems and is described on their website at http://www.aerogel.com.

An alternative type of aerogel material for use in connection with the present invention comprises a vacuum insulated panel containing the aerogel material, which is normally granular in form, rather than being of monolithic structure. Examples of this type of construction are shown in U.S. Pat. Nos. 6,010,762 (to D. M. Smith et al.) and 6,132,837 (to R. U. Boes et al.), which patents are each also incorporated herein by reference. A current commercial supplier of such a product, under the trademark NANOGEL, is Cabot Corporation.

The Figure, which forms a portion of this Specification, illustrates a typical overhead rolling door 10 comprising a plurality of linked slats 12, 14, and 16 each containing an aerogel insulating composition 15 of any of the foregoing types.

The person of ordinary skill in the art can design aerogel insulation structures, in accordance with this invention, which will preferably substantially fill the hollow space within the slats or panels of the overhead door to provide maximum insulation effect. If a monolithic, fiber-reinforced monolithic aerogel structure is selected for use, it can be designed to have a length that matches the width of the door. Alternatively, shorter lengths of such an aerogel structure can be abutted to one another within each hollow slat or panel to substantially fill that structure or a longer length of such a monolith can be cut to the proper width to fill the slat or panel. In the case of vacuum insulated panels, the panels can also be designed to be of substantially the same width of the door or shorter lengths can be abutted to one another to appropriately fill that space. One design possibility, which is believed to be novel, is to have a plurality of standard lengths (e.g., one foot in length) of such aerogel-containing panels constructed in a single web-like construction with a thin perforation in the web between each aerogel-containing panel. This will allow for one or more of such perforation(s) to be ripped to separate adjacent panels, thereby creating a construct of the proper length to either match the width of the door or to produce multiple constructs that can be abutted to appropriately fill the interior space in the slat or panel of the overhead door.

Aerogel has a combination of features that makes it extremely attractive for use in accordance with the present invention. First, it is an excellent insulation material. Second, since it is an extremely porous form of silica, it has a very light weight that should assist the raising and lowering of the overhead door. Third, it is also an exceptional sound deadener that will help suppress the transmission of unwanted sound through the door.

The Claims that follow indicate the scope of protection desired.

I claim:

1. In an insulated overhead door, which comprises a plurality of slats or panels defined by front, back, and side surfaces with an insulating material disposed therein, wherein the improvement comprises an aerogel material as the insulating material.

2. A door as defined in claim 1 wherein the aerogel material is a fiber-reinforced monolithic aerogel.

3. A door as defined in claim 2 wherein the fiber is a ceramic fiber.

4. A door as defined in claim 1 wherein the aerogel material is a vacuum insulated panel containing aerogel material.

5. A door as defined in claim 4 wherein the aerogel material is in granular form.

6. A door as defined in claim 1 where the aerogel material substantially fills the hollow space within the slats or panels of the door.

7. A door as defined in claim 2 where the aerogel material substantially fills the hollow space within the slats or panels of the door.

8. A door as defined in claim 3 where the aerogel material substantially fills the hollow space within the slats or panels of the door.

9. A door as defined in claim 4 where the aerogel material substantially fills the hollow space within the slats or panels of the door.

10. A door as defined in claim 5 where the aerogel material substantially fills the hollow space within the slats or panels of the door.

11. A web comprising a plurality of aerogel-filled vacuum insulated panels having at least perforation between one or more of such panels allowing for separation of one or more aerogel-filled vacuum insulated panels from each other.

12. A web as defined in claim 11 wherein the aerogel material is in granular form.
